(19) United States
(12) Patent Application Publication
(10) Pub. No.: US 2004/0098523 A1
(43) Pub. Date: May 20, 2004

(54) Disk drive arrangement, enclosure, adapter and method

(75) Inventors: Reginald Beer, Eastleigh (GB); Robert Frank Maddock, Christchurch (GB); Michael Alan Veal, Southampton (GB)

Correspondence Address: BRACEWELL & PATTERSON, L.L.P., P.O. BOX 969, AUSTIN, TX, 78767-0969, US

(73) Assignee: International Business Machines Corp., Armonk, NY

(21) Appl. No.: 10/643,037

(22) Filed: Aug. 18, 2003

(30) Foreign Application Priority Data
Aug. 22, 2002 (GB) 0219570.9

(51) Int. Cl. G06F 13/12; G06F 13/38

(52) U.S. Cl. 710/74

(57) ABSTRACT

A disk drive arrangement (5) is provided for use in a disk drive enclosure having a number of such arrangements. The enclosure is arranged to provide enclosure services to the arrangement (5). Each arrangement (5) includes a disk drive (10) and an adapter (14) coupled between the disk drive (10) and a serial data connection 40 to a serial bus of the enclosure. The adapter includes serial to non-serial circuitry (30), such that the interface is coupled non-serially (15, 35) to the disk drive (10) and serially (40) to the bus. The bus is connected to an enclosure services processor in the enclosure. In this way enclosure services data may be exchanged between the processor and each arrangement (5) of the enclosure, thus providing enclosure services to each disk drive (10) of the enclosure with a serial bus.

### PRIORITY CLAIM

This application claims the priority of United Kingdom Patent Application No. 0219570.9, filed on Aug. 22, 2002, and entitled “Disk Drive Arrangement, Enclosure, Adapter and Method.”

### BACKGROUND OF THE INVENTION

1. Technical Field

The present invention relates to disk drive arrangements. More particularly, the present invention relates to a disk drive enclosure housing multiple disk drives, in which each disk drive can selectively communicate serially or non-serially within the disk drive enclosure.

2. Description of Related Art

In the field of this invention it is known for a number of fiber channel disk drives to be housed together in a common enclosure. Typically, such an arrangement may include the use of SCSI (Small Computer Systems Interface) services provided to each disk of the enclosure via an Enclosure Services Interface (ESI).

A typical design of such an enclosure includes a number of modules. First, bolted into the enclosure chassis is a backplane. Onto this backplane are plugged all other modules. Modules plugged into the backplane are concurrently maintainable, that is, they may be unplugged, removed and replaced without interrupting system operation.

This means that the backplane itself cannot be concurrently maintainable since it acts as a connecting medium for all other modules. The backplane module must therefore be designed to be of extremely high reliability. This is normally achieved by minimizing the active (transistorized) components on the backplane.

The other two modules of significance to the present invention are the disk drive carrier and the ESI processor. Both of these modules must plug into and communicate through the backplane.

The ESI itself is described by the Small Form Factor (SFF) Committee's specification numbers SFF8045 and SFF8067. These describe an arrangement using eight wires per disk, each disk being connected independently to the ESI processor. Present disk arrangements having a number n drives each with ESI capability therefore have 8*n wires connected to the ESI.

Therefore a problem exists in that for an enclosure containing 15 disks, to provide ESI on each disk would require 15 sets of 8 wires, namely 120 separate connections to the enclosure's controlling microprocessor. Space for a connector this large is difficult to find, as is routing space for the copper connections in the backplane PCB (Printed Circuit Board).

A known solution to this problem is to provide ESI to only a few (typically two or three) drive bays in a single enclosure. However such an approach has implications on the reliability and serviceability of the enclosure and renders any diagnostic tools more complex.

A need therefore exists for a disk drive arrangement with ESI functionality wherein the abovementioned disadvantage may be alleviated.

### SUMMARY OF THE INVENTION

In accordance with a first aspect of the present invention there is provided a disk drive enclosure for housing a plurality of disk drives, the enclosure being arranged to provide enclosure services to the plurality of disk drives, the enclosure comprising: an enclosure services processor; at least one disk drive arrangement including a disk drive and a serial adapter coupled non-serially thereto; a serial data bus coupled between the enclosure services processor and the at least one serial adapter; wherein the at least one serial adapter is arranged for communicating serially with the enclosure services processor and non-serially with the at least one respective disk drive, such that enclosure services data may be exchanged therebetween.

In accordance with a second aspect of the present invention there is provided a disk drive arrangement for use in a disk drive enclosure having a number of disk drives and being arranged to provide enclosure services via an enclosure services processor, the arrangement comprising: a disk drive; and, a serial adapter coupled non-serially to the disk drive and arranged for coupling via a serial data bus of the enclosure to the enclosure services processor; wherein the serial adapter is arranged for communicating serially with the enclosure services processor and non-serially with the disk drive, such that enclosure services data may be exchanged therebetween.

In accordance with a third aspect of the present invention there is provided an adapter for coupling between a disk drive and an enclosure, the enclosure having a number of disk drives and being arranged to provide enclosure services via an enclosure services processor, the adapter comprising: means for coupling non-serially to the disk drive; means for coupling via a serial data bus of the enclosure to the enclosure services processor; wherein the adapter is arranged for communicating serially with the enclosure services processor and non-serially with the disk drive, such that enclosure services data may be exchanged therebetween.

In accordance with a fourth aspect of the present invention there is provided a method for providing enclosure services to a disk drive enclosure having at least one disk drive, the method comprising the steps of: initiating a request for enclosure services from the at least one disk drive, transmitting the request to a serial adapter coupled non-serially to the disk drive; translating the request into serial data via serial conversion means of the serial adapter; transmitting the serial data from the serial adapter to an enclosure services processor of the enclosure via a serial data bus coupled therebetween; transmitting serial enclosure services data from the enclosure services processor to the serial adapter via the serial data bus in response to the request; translating the serial enclosure services data into non-serial enclosure services data via the serial conversion means; receiving the non-serial enclosure services data at the disk drive.

Preferably the adapter is a discrete element interposed between the disk drive and the enclosure. Alternatively the adapter may be integrated with interfacing circuitry of the enclosure.

The serial data bus is preferably a three line serial data bus. Alternatively the serial data bus preferably comprises a two line serial data bus and a discrete interrupt connection between the adapter and the enclosure services processor.

Preferably the disk drive has an address connection for selectively coupling to one of address lines and the serial conversion arrangement, wherein the adapter includes data switching circuitry arranged to selectively switch the address connection between the address lines and the serial conversion arrangement. The serial data bus is preferably arranged to operate with an I2C serial protocol.

In this way a disk drive arrangement, enclosure, adapter and method are provided in which the number of wires required to provide enclosure services to all disk drives of an enclosure is significantly reduced. Furthermore disk drive spaces may be populated in an enclosure in any sequence.

### BRIEF DESCRIPTION OF THE DRAWINGS

One disk drive arrangement, enclosure, adapter and method incorporating the present invention will now be described, by way of example only, with reference to the accompanying drawings, in which:

FIG. 1 shows a block schematic diagram of a disk drive arrangement incorporating the present invention;

FIG. 2 shows a block schematic diagram of an enclosure including an number of disk drive arrangements according to FIG. 1; and

FIG. 3 shows an illustrative flow diagram of ESI operation of the enclosure of FIG. 2 and the arrangement of FIG. 1.

### DETAILED DESCPRIPTION OF A PREFERRED EMBODIMENT

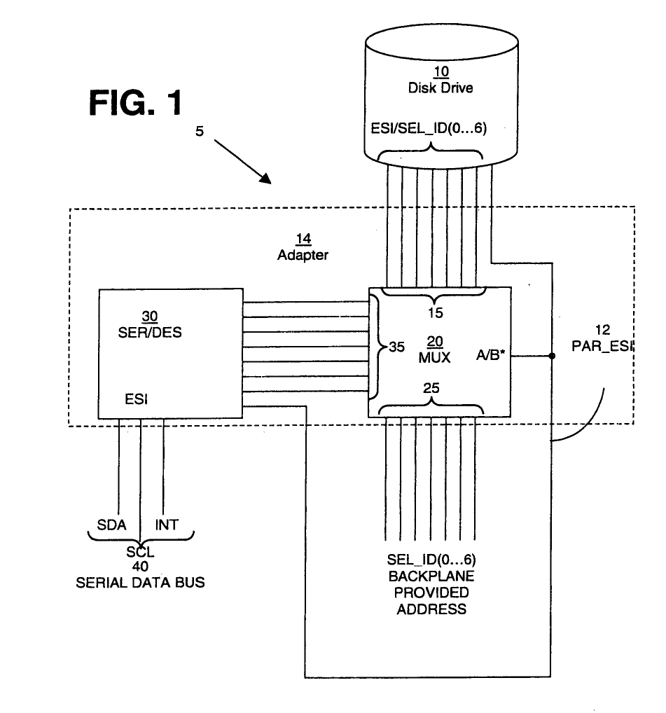

Referring now to FIG. 1 there is shown a disk drive arrangement 5 comprising a disk drive 10 and a serial adapter 14 comprising a multiplexer (MUX) 20 and a serializer/deserializer (SERDES) 30. The SERDES 30 is a simple logic device that can convert a number of bi-directional data lines (parallel data) into a serial data stream, and vice-versa. The SERDES 30 is coupled to the MUX 20 and the disk drive 10 via 7 IO lines 35, and provides a serial interface 40 to an ESI processor to be further described below.

The MUX 20 is coupled to EsI/SEL ID(0 . . . 6) 10 lines 15 of the disk drive 10 and also to a backplane provided SELID(0 . . . 6) address lines 25 and to the IO lines 35 of the SERDES 30.

A PAR_ESI line 12 is coupled between the disk drive 10, the MUX 20 and the SERDES 30. The MUX 20 is arranged to selectively connect the 10 lines 15 to either the address lines 25 or the 10 lines 35, in dependence upon the state of the PAR ESI line 12, whose state is determined by the disk drive 10, in a manner to be further described below.

The MUX 20 is seven bits wide and bi-directional, acting like a digital cross point switch. The MUX 20 may be implemented using two 74HCT4066 devices.

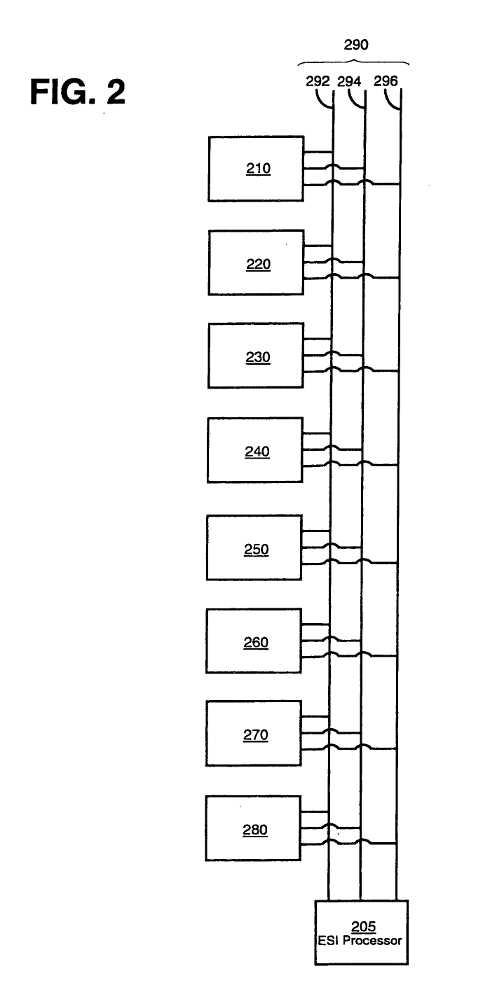

Referring now also to FIG. 2, there is shown an ESI port bus arrangement, showing eight disk drive arrangements (210-280) each with three wire ESI ports provided by a serial adapter as described above and each coupled to an ESI processor 205 via a serial bus 290.

This bus may be implemented using off the shelf 12C components. If I2C Components are used, the bus comprises a Serial DAta (SDA) line 292, a Serial CLock (SCL) line 294 and an INTerrupt (INT) line 296. In this way the number of lines required to implement enclosure services for all 8 disk drive arrangements 210-280 of a single enclosure is reduced from the prior art arrangement of 64 wires to three wires. The disk drive arrangement 210 represents the arrangement 5 of FIG. 1.

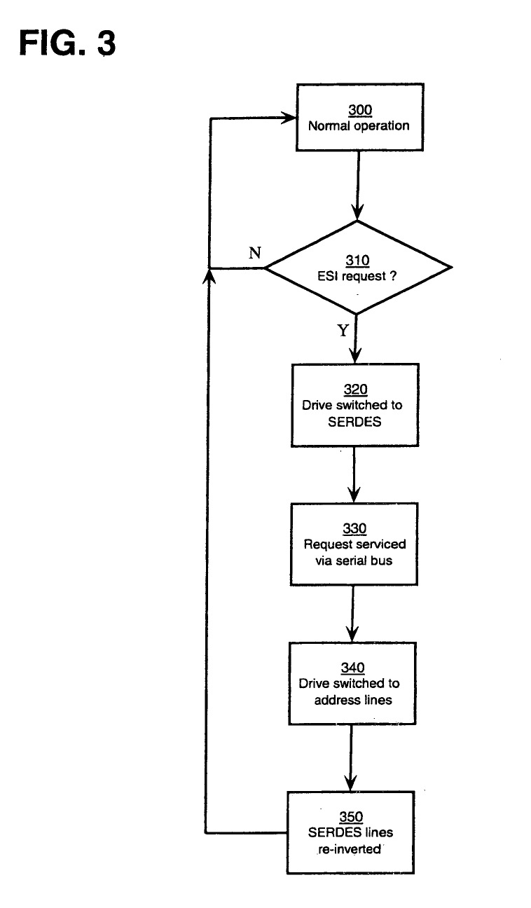

Referring now also to FIG. 3, there is shown an illustrative flow diagram of ESI operation with respect to the arrangements of FIG. 1 and FIG. 2.

In a normal state, when the disk drive 10 is not requesting ESI data from the ESI processor 205 (block 300), the PAR_ESI line 12 from the disk drive 10 is high and the IO lines 15 are coupled via the MDX 20 to the backplane provided SEL_ID address lines 25. The address lines 25 are used by the disk drive 10 whilst it obtains a FC-AL (Fibre Channel Arbitrated Loop) address.

If the disk drive 10 does request ESI services (block 310 affirmed) it sets the PAR ESI line 12 to low, thus switching the MUX 20, which disconnects the IO lines 15 from the address lines 25 and instead couples them to the 10 lines 35 of the SERDES 30 (block 320).

It is a requirement of the SFF8067 specification that the SEL_ID IO lines 15 are inverted by the ESI processor 205 within 1/is of the PAR ESI line 12 going low. The SERDES 30 is therefore pre-programmed by the ESI processor 205 with the SEL_ID IO lines 35 being inverted.

The ESI processor 205 then transfers the ESI data to the disk drive 10/210 via the serial bus 290 (block 330) and serial adapter 14. When completed, the disk drive 10 releases the PAR_ESI line 12 to a high state. The MUX 20 then switches the IO lines 15 back to the address lines 25 (block 340).

The ESI processor 205 must then re-program the inverted IO lines 35 of the SERDES 30 (block 350). The arrangement is thus returned to its normal operating state(block 300), and the SERDES 30 is ready for the next ESI request.

When using the 12C components, this will take a minimum of 5/is, 2.5/is (see below for further details) to read the SERDES 30 and to determine that the PAR_ESI line 12 has been released and 2.5/is to write the inverted address to the SERDES 30.

During this time, if the disk drive 10 were to request further ESI activity, then the disk drive 10 would time out the access or provide faulty SFF8045 style data. If such latency is unacceptable, then further logic could be added to automatically provide the inverted programming of the IO lines 35.

If a Philips PCF8575 16 bit 12C register is used for the SERDES 30, an interrupt will be generated when the PAR_ESI line 12 changes state.

It will be appreciated that any one or two wire serial communication protocol may be used for this purpose. In the present embodiment the Philips proprietary 12C standard is used. The support components and timing considerations that arise from this approach are further described below.

For the example shown in FIG. 2, the ESI processor 205 must poll each of the disk drive arrangements 210-280 to determine which one(s) of them are requesting an ESI connection.

In an alternative embodiment (not shown) the INT line 296 is replaced by individual interrupt lines from each of the disk drive arrangements. These are coupled discretely to the ESI processor 205. With such an arrangement the ESI processor 205 may immediately address the requesting disk drive arrangement, at the expense of providing one interrupt line per arrangement and two further bussed lines. Therefore in the example of FIG. 2 there would be ten lines from the ESI processor 205 rather than three.

A further advantage of having interrupt lines discretely coupled to the ESI processor 205 is speed, as additional accesses of the SERDES 30 must be performed if the interrupt lines are bussed.

With discrete interrupt lines, the following data rates are possible:

The PCF8575 is a 16-bit latch capable of operating at 400 KHz. A seven bit address and a read/write bit as well as all 16 bits must be written or read each time the device is accessed.

As described above, the time for each access to the PCF8575 and thus the time taken to transfer one byte (8 bits) of data is 2.5/is, this being given by:

| | |
|---|---|
| Start bit | 1 cycle |
| Address | 7 cycles |
| Read/Write | 1 cycle |
| Acknowledge bit | 1 cycle |
| Data bits | 8 cycles |
| Acknowledge bit | 1 cycle |
| Data bits | 8 cycles |
| Acknowledge bit | 1 cycle |
| Stop bit | 1 cycle |
| Total | 29 cycles |
| | @ 400 KHz = 2.5 μs. |

For a write phase (from disk to enclosure), the disk asserts one nibble (4 bits) of data and waits 100 ns before asserting a DS_KWR* signal. The PCF8575 will raise an interrupt as soon as the data is asserted and the 100 ns delay is therefore irrelevant in this respect.

The enclosure processor must read the data (access #1, I2C read) and then set the ENCL_ACK* signal (access #2, I2C write).

When the disk spots the EN_CLACK* signal asserted, it releases DSK_WR* (no access necessary an INT will be raised) and the ESI processor 205 is then expected to release ENCL_ACK* (access #3, I2C write). Once this is done, the next phase may begin.

Therefore three accesses are required for each nibble, six for each byte. The maximum theoretical write transfer rate is 66.6K bytes per second.

For a read phase (from enclosure to disk), the disk drive 10 asserts DSK_RD*, an interrupt is generated and the enclosure must read the I2C register to find out what is happening (access #1, I2C read).

The ESI processor 205 must now assert the data nibble (access #2, I2C write), and then, a minimum of 100 ns later assert the ENCLACK* signal (access #3, I2C write).

The disk drive 10 reads the data and de-asserts DSK_RD* (no access required, the ESI processor 205 will receive an interrupt). The ESI processor 205 must now de-assert ENCL_ACK* (access #4, I2C write). Once this is done, the next phase may begin.

Therefore four accesses are required for each nibble, eight for each byte. The maximum theoretical read transfer rate is 50K bytes per second.

The serial adapter 14 described above may be physically located either on the backplane or in the disk carrier (via an interposing circuit). Mounting the serial adapter in the disk carrier may require the implementation of a non-standard backplane to disk connector, or the use of a standard connector with a non-standard pinout.

If the non-standard pinout is chosen, some functions normally provided directly by the backplane must be provided by spare I/O ports on the SERDES 30. The obvious candidates for this are the two START lines. By moving these signals onto the SERDES 30, other signals may also be reclaimed without timing constraints, as the disk drive will not sample other signals until it detects “go” status on the START lines.

Further advantages to using an interposing solution for the serial adapter 14 are that it does not adversely affect backplane failure rate (it improves it as there are fewer pins on the connectors). In contrast, mounting the components on the backplane will adversely affect the backplane failure rate.

An interposing serial adapter solution does not add cost to the rack unit. The cost is added to each drive carrier. This makes no difference to a fully populated enclosure, but lowers the cost of an entry level (unpopulated) enclosure.

The interposing serial adapter solution does introduce an impedance discontinuity and some attenuation into the fiber channel path. However, the physical feature size of any discontinuity is limited to the thickness of the interposer PCB (the connectors are typically impedance controlled) which at between 1-1.5 mm is an insignificant amount with the edge rates used at 2 GB/s fiber channel. Attenuation is also expected to be insignificant compared to the losses in the lengthy runs of transmission lines needed for each disk.

The I2C address for each PCF8575 may be programmed using three binary inputs (hence eight devices may be connected to a single I2C bus). It is recommended to connect these three address pins to the SEL_ID wires provided to each disk bay. In this way, the address of the PCF8575 will follow the drive slot.

It will be understood that the arrangement described above provides the following advantages:

The number of wires required to provide enclosure services to all disk drives of an enclosure are significantly reduced.

Disk drive spaces may be populated in an enclosure in any sequence, because providing enclosure services to only 2 or 3 disk drives restricts the enclosure to a fixed population sequence.

Improved diagnostic software may be envisaged with the present invention, such as a diagnostic arrangement able to communicate via ESI with all the disk drives in an enclosure, and a mechanism to isolate a disk drive with a faulty FC-AL transceiver from the loop.

It is also envisaged that FC-AL link error statistics may be obtained via the ESI processor.

It will be appreciated by a person skilled in the art that alternative embodiments to those described above are possible. For example, the serial communication protocol used and the number of wires of the serial bus may differ from those shown above.

Furthermore the number of disk drives and the arrangement of connections thereto may differ in detail from that described above.

What is claimed is:

1. A disk drive enclosure for housing a plurality of disk drives, the enclosure being arranged to provide enclosure services to the plurality of disk drives, the enclosure comprising:
an enclosure services processor;
at least one disk drive arrangement including a disk drive and a serial adapter coupled non-serially thereto;
a serial data bus coupled between the enclosure services processor and the at least one serial adapter;
characterized in that the at least one serial adapter is arranged for communicating serially with the enclosure services processor and non-serially with the at least one respective disk drive, such that enclosure services data may be exchanged therebetween.

2. The enclosure of claim 1 characterized in that the disk drive has an address connection for selectively coupling to one of addressing means and the adapter and wherein the adapter includes data switching means and serial conversion means, the data switching means being arranged to selectively switch the address connection between the addressing means and the serial conversion means.

3. The enclosure of claim 2 characterized in that the serial data bus is arranged to operate with an I2C serial protocol.

4. The enclosure of claim 3 characterized in that the adapter is a discrete element interposed between the disk drive and the enclosure.

5. The enclosure of claim 4 characterized in that the serial data bus is a three line serial data bus.

6. The enclosure of claim 4 characterized in that the serial data bus comprises a two line serial data bus and a discrete interrupt connection between the adapter and the enclosure services processor.

7. The enclosure of claim 3 characterized in that the adapter is integrated with interfacing circuitry of the enclosure.

8. The enclosure of claim 7 characterized in that the serial data bus is a three line serial data bus.

9. The enclosure of claim 7 characterized in that the serial data bus comprises a two line serial data bus and a discrete interrupt connection between the adapter and the enclosure services processor.

10. A disk drive arrangement for use in a disk drive enclosure having a number of disk drives and being arranged to provide enclosure services via an enclosure services processor, the arrangement comprising:
a disk drive; and,
a serial adapter coupled non-serially to the disk drive and arranged for coupling via a serial data bus of the enclosure to the enclosure services processor; characterized in that the serial adapter is arranged for communicating serially with the enclosure services processor and non-serially with the disk drive, such that enclosure services data may be exchanged therebetween.

11. The arrangement of claim 10 characterized in that the disk drive has an address connection for selectively coupling to one of addressing means and the adapter and wherein the adapter includes data switching means and serial conversion means, the data switching means being arranged to selectively switch the address connection between the addressing means and the serial conversion means.

12. The arrangement of claim 11 characterized in that the serial data bus is arranged to operate with an I2C serial protocol.

13. The arrangement of claim 12 characterized in that the adapter is a discrete element interposed between the disk drive and the enclosure.

14. The arrangement of claim 13 characterized in that the serial data bus is a three line serial data bus.

15. The arrangement of claim 13 characterized in that the serial data bus comprises a two line serial data bus and a discrete interrupt connection between the adapter and the enclosure services processor.

16. The arrangement of claim 12 characterized in that the adapter is integrated with interfacing circuitry of the enclosure.

17. The arrangement of claim 16 characterized in that the serial data bus is a three line serial data bus.

18. The arrangement of claim 16 characterized in that the serial data bus comprises a two line serial data bus and a discrete interrupt connection between the adapter and the enclosure services processor.

19. An adapter for coupling between a disk drive and an enclosure, the enclosure having a number of disk drives and being arranged to provide enclosure services via an enclosure services processor, the adapter comprising:
means for coupling non-serially to the disk drive;
means for coupling via a serial data bus of the enclosure to the enclosure services processor;
characterized in that the adapter is arranged for communicating serially with the enclosure services processor and non-serially with the disk drive, such that enclosure services data may be exchanged therebetween.

20. The adapter of claim 19 characterized in that the disk drive has an address connection for selectively coupling to one of addressing means and the adapter and
wherein the adapter includes data switching means and serial conversion means, the data switching means being arranged to selectively switch the address connection between the addressing means and the serial conversion means.

21. The enclosure of claim 20 characterized in that the serial data bus is arranged to operate with an I2C serial protocol.

22. The enclosure of claim 21 characterized in that the adapter is a discrete element interposed between the disk drive and the enclosure.

23. The enclosure of claim 22 characterized in that the serial data bus is a three line serial data bus.

24. The enclosure of claim 22 characterized in that the serial data bus comprises a two line serial data bus and a discrete interrupt connection between the adapter and the enclosure services processor.

25. The enclosure of claim 21 characterized in that the adapter is integrated with interfacing circuitry of the enclosure.

26. The enclosure of claim 25 characterized in that the serial data bus is a three line serial data bus.

27. The enclosure of claim 25 characterized in that the serial data bus comprises a two line serial data bus and a discrete interrupt connection between the adapter and the enclosure services processor.

28. A method for providing enclosure services to a disk drive enclosure having at least one disk drive, the method comprising the steps of:
initiating a request for enclosure services from the at least one disk drive, transmitting the request to a serial adapter coupled non-serially to the disk drive;
translating the request into serial data via serial conversion means of the serial adapter;
transmitting the serial data from the serial adapter to an enclosure services processor of the enclosure via a serial data bus coupled therebetween;
transmitting serial enclosure services data from the enclosure services processor to the serial adapter via the serial data bus in response to the request;
translating the serial enclosure services data into non-serial enclosure services data via the serial conversion means;
receiving the non-serial enclosure services data at the disk drive.

29. The method of claim 28 characterized in that the serial data bus is arranged to operate with an I2C serial protocol.

30. A disk drive enclosure for housing a plurality of disk drives, the enclosure comprising:
an enclosure services processor;
a serial data bus coupled between the enclosure services processor and a serializer/deserializer; and
a multiplexer coupled to the serializer/deserializer, a disk drive and a non-serial backplane interface, wherein the multiplexer selectively outputs parallel data from the disk drive to either the serializer/deserializer or the non-serial backplane interface, such that communication with the disk drive is selectively serial or non-serial.

31. The disk drive enclosure of claim 30, wherein the non-serial communication is with another disk drive in the disk drive enclosure via the non-serial backplane interface, and the serial communication is with another disk drive in the disk drive enclosure via the serial data bus whose data traffic is under the control of the enclosure services processor.
